(19) United States
(12) Patent Application Publication
(10) Pub. No.: US 2022/0329902 A1
(43) Pub. Date: Oct. 13, 2022

(54) METHODS AND APPARATUS TO DETERMINE DIGITAL AUDIO AUDIENCE REACH ACROSS MULTIPLE PLATFORMS

(71) Applicant: The Nielsen Company (US), LLC, New York, NY (US)

(72) Inventors: Kelly Marie Dixon, Sykesville, MD (US); Katherine Terfler Williams, Columbia, MD (US); Frank Fasinski, Columbia, MD (US); Emma Youmans Handzo, Columbia, MD (US); Khaldoon Abu-Hakmeh, Columbia, MD (US); Emily Neuhoff, Columbia, MD (US); Furqan Hanif, Tampa, FL (US); Edward Murphy, North Stonington, CT (US); Jennifer Carton, Columbia, MD (US); Molly Poppie, Chicago, IL (US); Jonathan Ouegnin, Raleigh, NC (US); Miranda Riggs, Chicago, IL (US); Andy Golub, Columbia, MD (US); Allysha Kochenour, Columbia, MD (US)

(21) Appl. No.: 17/717,017

(22) Filed: Apr. 8, 2022

Related U.S. Application Data
(60) Provisional application No. 63/172,369, filed on Apr. 8, 2021.

(51) Int. Cl. H04N 21/442

(52) U.S. Cl. CPC H04N 21/44204

(57) ABSTRACT

Methods, apparatus, systems, and articles of manufacture are disclosed to determine digital audience reach across multiple platforms. An example apparatus includes audience data receiver circuitry to obtain first audience data from a first media platform; and processor circuitry to perform at least one of the first operations, the second operations, or the third operations to instantiate: activity analyzer circuitry to determine media activities in the first audience data; adjustment analyzer circuitry to: apply at least one adjustment factor to the first audience data based on a source of the audience data; apply a coverage factor adjustment to the first audience data; and output the adjusted first audience data as a deduplicated audience for the first media platform.

### RELATED APPLICATION

This patent claims the benefit of U.S. Provisional Patent Application No. 63/172,369, which was filed on Apr. 8, 2021. U.S. Provisional Patent Application No. 63/172,369 is hereby incorporated herein by reference in its entirety. Priority to U.S. Provisional Patent Application No. 63/172,369 is hereby claimed.

### FIELD OF THE DISCLOSURE

This disclosure relates generally to audience measurement, and, more particularly, to methods, systems, machine readable media, and apparatus to determine digital audience reach across multiple platforms.

### BACKGROUND

Audience Measurement Entities collect and analyze information about media accesses and presentations to facilitate better understanding of the audiences for such media. For example, audience measurement information may be utilized for determining the value of advertising spots in the media. Audience measurement entities can facilitate the accurate and impartial reporting of audience information.

### BRIEF DESCRIPTION OF THE DRAWINGS

FIG. 1 is block diagram of an example environment in which an audience analyze circuitry operates to collect and analyze audience information to determine deduplicated audiences.

FIG. 2 is an illustration of example relationships between example users, internet protocol (IP) addresses, and platforms.

FIG. 3 is an illustration of the relationship and overlap of audiences among multiple platforms in a media distribution system.

FIG. 4 is a flowchart representative of example machine readable instructions and/or example operations that may be executed by example processor circuitry to implement the audience analyzer circuitry of FIG. 1.

FIG. 5 is an illustration of the analysis of two example platforms and the overlap among the platforms.

FIG. 6 is a block diagram of an example processing platform including processor circuitry structured to execute the example machine readable instructions and/or the example operations of FIG. 4 to implement the audience analyzer circuitry of FIG. 1.

FIG. 7 is a block diagram of an example implementation of the processor circuitry of FIG. 6.

FIG. 8 is a block diagram of another example implementation of the processor circuitry of FIG. 6.

FIG. 9 is a block diagram of an example software distribution platform (e.g., one or more servers) to distribute software (e.g., software corresponding to the example machine readable instructions of FIG. 4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

In audience measurement contexts it is desirable to provide deduplicated reach, audience measurement, for a client across platforms and for key combinations of the multiple platforms. Persons-level audience may be based on advertisement (or other content) impressions that occur during streaming music, streaming podcasts, and downloaded podcasts. It may be desirable to convert downloaded content to persons who actually listened (e.g., audience). Current measurement of downloads in the industry is likely over-counting advertisement impressions. Methods and apparatus disclosed herein compute reach based on research and data analysis with assumptions and factors applied.

Methods and apparatus disclosed herein use models and factors to account for 1) coverage errors from a client's server data, 2) a model of the relationship between user identifiers and internet protocol (IP) addresses, and 3) a factor from a podcast (or other digital media) behavior survey to account for podcasts (or other digital media) that were downloaded but never listened to. The methods and apparatus additionally deduplicate across multiple client platforms (e.g., three platforms, four platforms, etc.) into distinct categories so that a client can see their audience reach for one platform or any combination of the platforms.

Methods and apparatus disclosed herein provide people based estimated audiences for multiple media platforms (e.g., multiple podcast platforms from a single provider) (streams and downloads) and music streams for a given month for the US (data provided by a client). Examples of these include:
Total audience reach across all podcasts (streams and downloads) and music streams on multiple platforms.
Platform A-Only—Audience reach across all podcasts (streams and downloads) and music streams
Platform B-Only—Audience reach across all podcast (downloads+streams)
Platform C-Only—Audience reach across all podcast (downloads+streams)
Platform A and Platform B—Audience reach across all music streams and podcast (downloads+streams)
Platform A+Platform C—Audience reach across all music streams and podcast (downloads+streams)
Platform B+Platform C—Audience reach across podcast (downloads+streams)

In some examples, the data provided by the media provider may include (with sample values):

Masked Unique User ID (e.g., Platform A Only): 1111111

Platform identifier: A or B or C

IP address: X.X.X.X (e.g., IP to unique user ID mapping may be for an example subset of all users in a client's platform(s). In other examples, different portions or the whole of the client's data may be used for mapping)

# of ad impressions/downloads (e.g., not available for Platform C): 5 (e.g., the number of downloads may not equal actual impressions because a user may download media without presenting)

Masked Unique Device ID (where available) (e.g., not available for Platform C): 111111

Timestamp: 12:22.22 20220405

Type of Impressions (e.g., Platform A only): Audio Stream or Podcast Stream or Podcast Download

There are several pathways for extending and improving the basic innovation described herein, mainly improved individual identification, greater access to client data, and improvements to survey methodology. Advanced individual identification can include demographics, weighting, third-party matching, proprietary audience measurement database matching, IP subnet analyses, and probabilistic linkages. The client-provided data can be understood and used in more sophisticated ways; additionally that data can be expanded by the client providing more information and/or by fusion with other datasets. Additional data from the client can support the development of more differentiated factors and more sophisticated models that are used to estimate audience. For example, treatment of monetizable/non-monetizable users could be differentiated, although in the current iteration they are treated in the same way. Another example is better understanding which devices are used to consume media and refining the models to be specific to that information. The survey itself can be expanded and edited to collect additional information as well as more specifically detailed information. Such information can improve the understanding of the human behavior related to consuming digital audio and this enriched understanding allows for more complex modeling. If greater data access is developed in a coordinated fashion with survey improvements, connections and behaviors in client and survey data can be better understood, leading to more sophisticated factors/models, and a deeper description of the client's audience. Finally, validity of assumptions, calculations of factors, and precision of measurement can increase as we work with more time and gain better appreciation of the data.

In some implementations, the methods and apparatus disclosed herein meet some or all of the following goals:
Provide deduplicated reach for multiple platforms combined, and for key combinations of the multiple platforms. Persons-level audience may be based on ad impressions that occur during streaming music, streaming podcasts, and downloaded podcasts.
Methodology converts downloaded content to unique/deduplicated persons who actually listened (audience). Current measurements of downloads likely over-counts ad impressions.

Examples of metrics to be analyzed include:
Total Audience Reach
Platform A-Only Reach
Platform B-Only Reach
Platform C-Only Reach
Platform A+Platform B Combined Reach
Platform A+Platform C Combined Reach
Platform B+Platform C Combined Reach

The methods and apparatus may address these goals in view of situations in which an example client's data does not contain an exhaustive list of IP addresses, IP addresses are not the same as people, and/or Downloading content is not the same as listening to it.

In some implementations, a client may provide an audience measurement entity with data that includes
Impression Context:
   Hashed user ID, music impressions, and podcast impressions
User and IP Mapping:
   Hashed user ID and IP address
Multiple platforms' IP Addresses:
   IP addresses and activity indicators for the multiple platforms

Data for multiple platforms to be analyzed may have unique characteristics. For example:
First Platform:
   30 seconds of streaming qualifies as activity
Second Platform:
   60 seconds of downloading qualifies as activity
Third Platform:
   Presence in a first example or in a second example dataset qualifies as activity

According to the example implementation disclosed herein, examples of assumptions taken into account may include the following:
One user identifier represents one individual
Streaming is assumed to be listened to right away and will therefore count as audience
Missing-at-random IP addresses are missing at the same rate in overlaps (e.g., first platform+second platform)

In some implementations to reduce the computation time, certain elements of the reach will be estimated using factors as time does not permit calculations on individual records.

In some implementations, audience will be reported on total persons level, demographic data modeling will not be incorporated. In other examples, demographic data or modeling of demographic data may be included. Creation of different factors by IP subnets is not utilized in the illustrated example, but may be implemented in the examples. Matching individual records to other audience measurement datasets and probabilistic record-matching may also be included in other implementations.

In some implementations, various factors may be determined and used to adjust the collected data with the goal of improving measurement accuracy. A coverage factor adjusts for coverage errors in the data (e.g., increases measurements to account for data that does not provide full coverage). A user to IP factor uses a model generated from analyzed data for a platform to model relationships among users and IP addresses (e.g., to determine an expected number of users given an identified number of IP addresses). A download factor adjusts collected data to relate a number of downloads or accesses of media to an expected number of presentations (e.g., viewings) (e.g., this factor may determine an audience that is fewer than the number of downloads based on a factor that indicates that some users download the media without presenting).

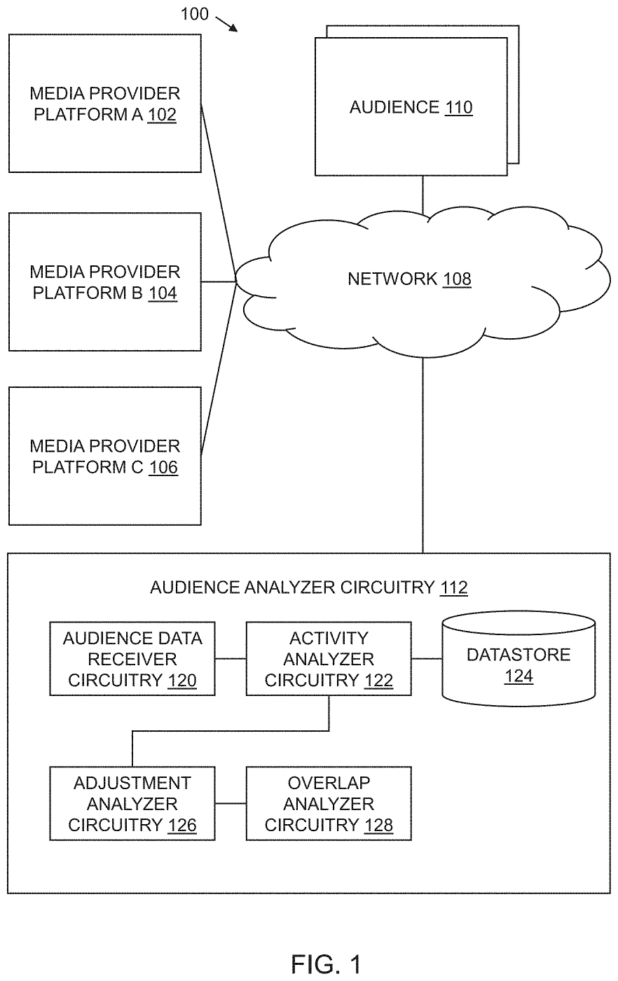

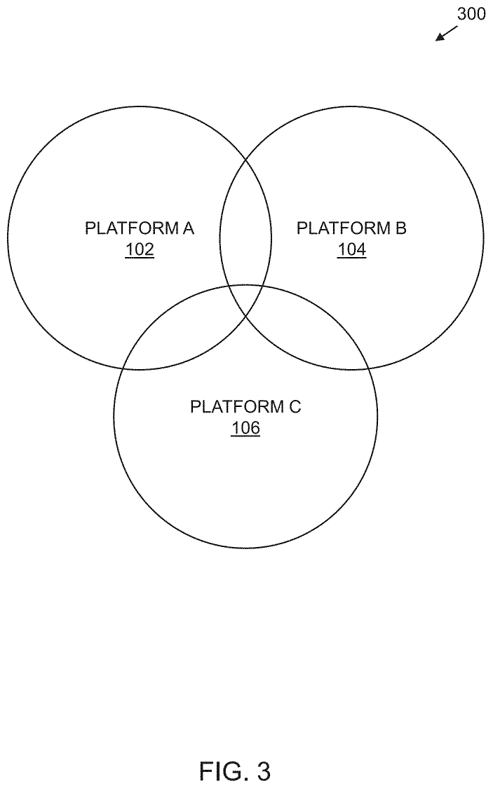

FIG. 1 is a block diagram of an example environment 100. The example environment 100 includes an example media platform A 102, an example media platform B 104, an example media platform C 106, an example network 108, an example audience 110, and an example audience analyzer circuitry 112. In the example environment 100, the example audience analyzer circuitry 112 analyzes data collected by the media platforms 102-106 to determine information about the audience 110 for the media platforms 102-106 and/or overlapping audiences for the media platforms 102-106. For example, FIG. 3 illustrates how an audience across the multiple media platforms 102-106 may be distributed such that some audiences are unique to a give platform, some audience overlap among two platforms, and some audiences overlap among all platforms. For example, an audience overlaps among two platforms when the same user accesses media from two of the platforms.

The example media platforms 102-106 are separate media distribution services from a media provider. For example, the media platform A 102 may be a music streaming service, the media platform B 104 may be an advertising distribution service, and the example media platform C 106 may be podcast distribution service. Alternatively, there may be any number of platforms and any combination of service types (e.g., video streaming, on demand video distribution, live media distribution, media download services, etc.). The example media platforms 102-106 are coupled to other components of the environment 100 via the example network 108.

The example network 108 is the Internet. Alternatively, the network 108 may be any type and/or combination of networks to communicatively couple the components of the environment 100. For example, the network 100 may include local area networks, wide area networks, wireless networks, commercial networks, private networks, short-range communication protocols (e.g., Bluetooth), direct connections, etc.

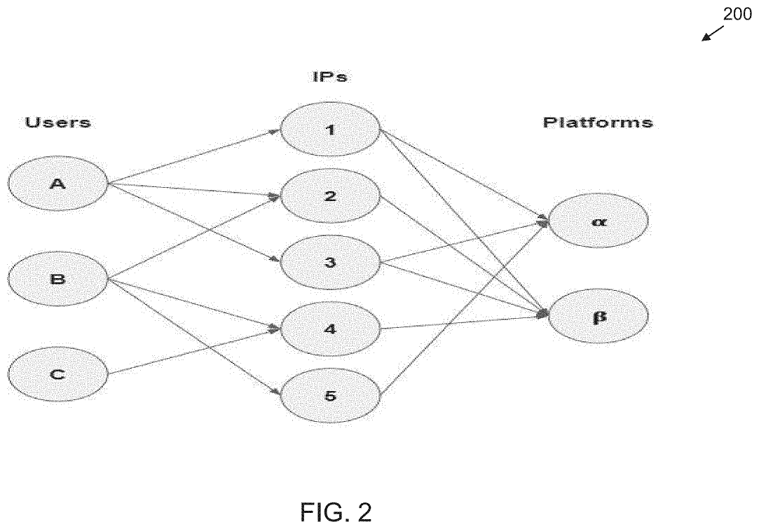

The example audience 110 is representative of the multiple users and/or devices that access the media provided by the example media platforms 102-106. For example, the audience 110 may include users that utilize mobile devices, desktop devices, etc. Devices of the audience 110 may access the media from a public IP address. As illustrated in FIG. 2, multiple users may be associated with the same IP address (e.g., multiple users in a single household) and an IP address may access multiple platforms. Accordingly, in some examples, the audience analyzer circuitry 112 adjusts the data from the media platforms 102-106 to disambiguate the data to determine unique users associated with the data.

The example audience analyzer circuitry 112 obtains data collected by the media platforms 102-106 (e.g., about accesses from the audience 110) and analyzes the data to determine unique and overlapping audiences for the media platforms 102-106.

The example audience analyzer circuitry 112 includes an example audience data receiver circuitry 120, an example activity analyzer circuitry 122, an example datastore 124, an example adjustment analyzer circuitry 126, and an example overlap analyzer circuitry 128.

The example audience data receiver circuitry 120 is circuitry to receive data from the example media platforms 102-106 via the example network 108. For example, the audience data receiver circuitry 120 may be a network adapter and processing circuitry to receive and decode the data. Alternatively, the audience data receiver circuitry 120 may be any other type and/or combination of circuitry to receive collected audience data. Additionally, in some examples, the audience data receiver circuitry 120 may access information defining how the collected data is to be interpreted. For example, the media platforms 102-106 may publish information/rules that indicate how an activity is defined within the data (e.g., a user activity is only counted once media has been accessed for a threshold amount of time (e.g., 30 seconds, 60 seconds, 90 seconds, etc.). When collected, such data may be stored in the datastore 124.

The example activity analyzer circuitry 122 analyzes the collected data to identify activities (e.g., qualified user activity that are to be measured). The example activity analyzer circuitry 122 access rules stored in the datastore 124 to determine when data qualifies as an activity (e.g., access that occur for less than a threshold time may not qualify as an activity).

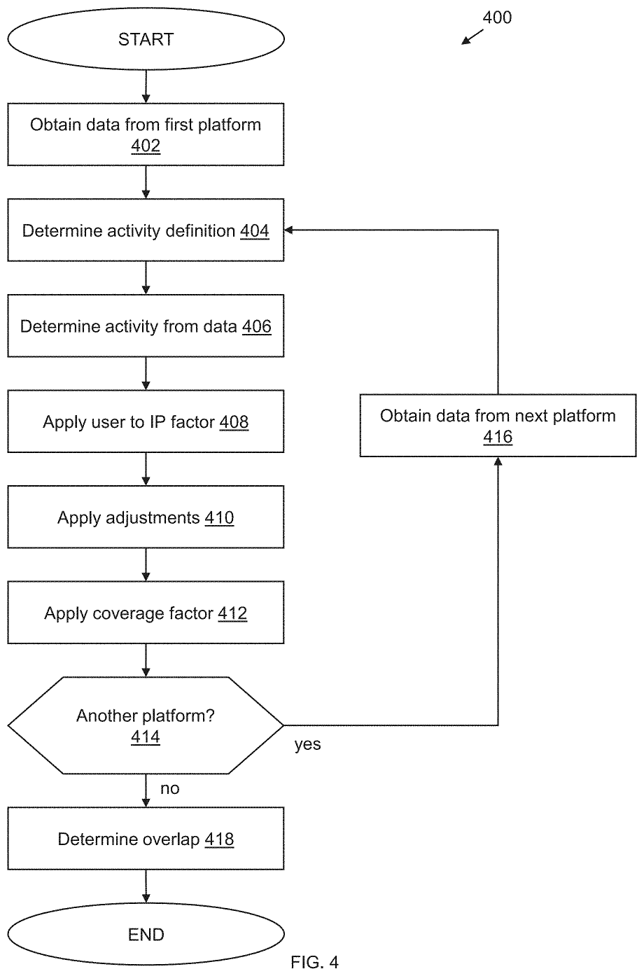

The example adjustment analyzer circuitry 126 receives the activity data from the example activity analyzer circuitry 122 and applies appropriate adjustments to the data to attempt to more accurately represent the actual details of the audience 110. For example, as described in conjunction with FIG. 4, the adjustment analyzer circuitry 126 may apply a user to IP adjustment factor, a download adjustment factor, a coverage factor, a missing IP factor, etc. According to the illustrated example, the output of the adjustment analyzer circuitry 126 is an estimated audience for one or more of the media platforms 102-106. The adjustment factors may be determined by analyzing samples of data from the media platforms 102-106 (e.g., to determine an estimate rate of IP address duplication among users, to determine an estimated rate of missing IP addresses assigned to duplicated users, etc. Additionally or alternatively, adjustment factors may be determined based on survey data. For example, an audience may be surveyed to determine rates of duplication, IP address reuse, etc.

The example overlap analyzer circuitry 128 analyzes the data from the adjustment analyzer circuitry 126 to determine an overlapping audience among two or more of the example media platforms 102-106.

The adjustment analyzer circuitry 126 and/or the overlap analyzer circuitry 128 may generate output with the determined audience information. For example, the audience information may be presented on a display, as an output report, as a report that is transmitted, etc. Furthermore, the analyzed data may be utilized to control other systems (e.g., the audience measurement data may be trigger events (e.g., actions when audience levels meet a threshold, monetary compensations, collection of new data, etc.).

While an example manner of implementing the audience analyzer circuitry 112 of FIG. 1 is illustrated in FIG. 1, one or more of the elements, processes, and/or devices illustrated in FIG. 1 may be combined, divided, re-arranged, omitted, eliminated, and/or implemented in any other way. Further, the example audience data receiver circuitry 120, the example activity analyzer circuitry 122, the example adjustment analyzer circuitry 124, the example overlap analyzer circuitry 128 and/or, more generally, the example audience analyzer circuitry 112 of FIG. 1, may be implemented by hardware alone or by hardware in combination with software and/or firmware. Thus, for example, any of the example audience data receiver circuitry 120, the example activity analyzer circuitry 122, the example adjustment analyzer circuitry 124, the example overlap analyzer circuitry 128, and/or, more generally, the example audience analyzer circuitry 112, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example audience analyzer circuitry 112 of FIG. 1 may include one or more elements, processes, and/or devices in addition to, or instead of, those illustrated in FIG. 1, and/or may include more than one of any or all of the illustrated elements, processes and devices.

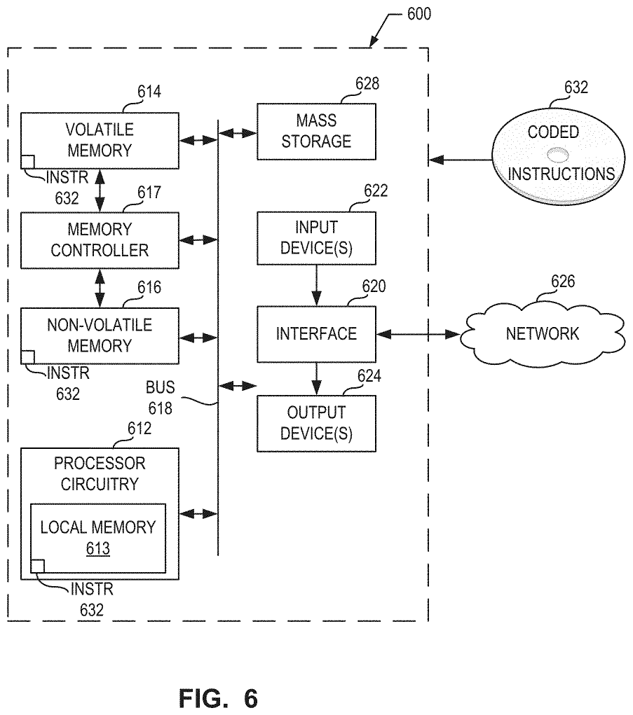

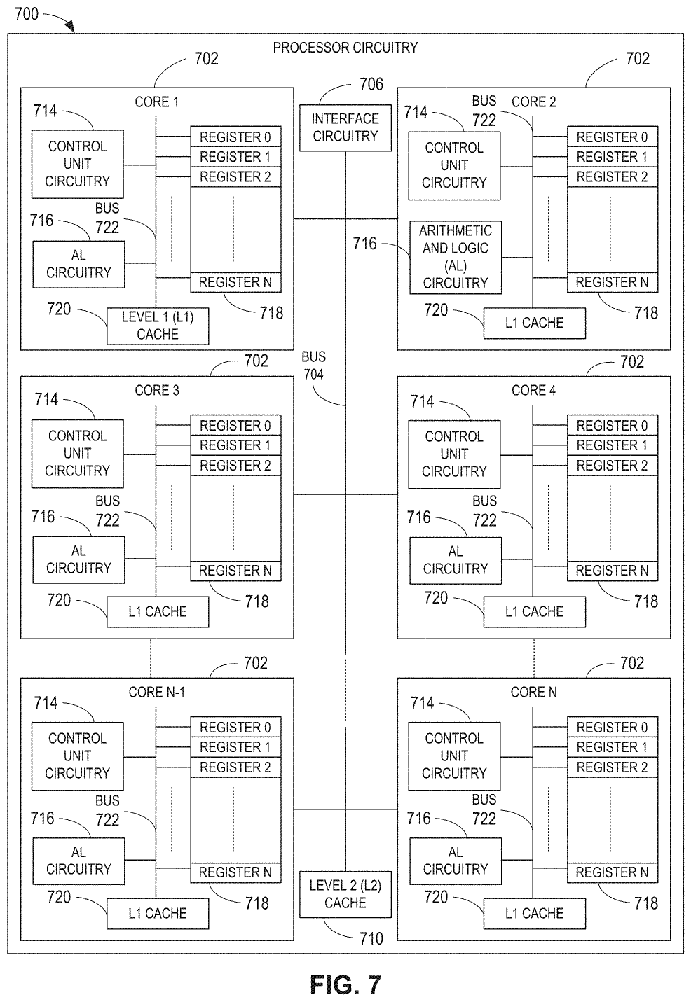

A flowchart representative of example hardware logic circuitry, machine readable instructions, hardware implemented state machines, and/or any combination thereof for implementing the audience analyzer circuitry 112 of FIG. 1 is shown in FIG. 4. The machine readable instructions may be one or more executable programs or portion(s) of an executable program for execution by processor circuitry, such as the processor circuitry 612 shown in the example processor platform 600 discussed below in connection with FIG. 6 and/or the example processor circuitry discussed below in connection with FIGS. 7 and/or 8. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 4, many other methods of implementing the example audience analyzer circuitry 112 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 4 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions and/or example operations 400 that may be executed and/or instantiated by processor circuitry to analyze an audience and determine an audience overlap. The machine readable instructions and/or the operations 400 of FIG. 4 begin at block 402, at which the audience data receiver circuitry 120 receives collected data from a first media platform (e.g., the media platform A 102). The example activity analyzer circuitry 122 determines an activity definition for the data (e.g., by retrieving one or more rules from the datastore 124 (block 404). The example activity analyzer circuitry 122 then determines activities from the data using the definition (block 406).

The example adjustment analyzer circuitry 126 then applies a user to IP factor to the data to determine a predicted number of unique users based on the number of unique IP addresses identified in the data (block 408). Next, the example adjustment analyzer circuitry 126 applies appropriate adjustment factors to the data (block 410). For example, the adjustment analyzer circuitry 126 may apply different adjustment factors to data from different media platforms 102-106 based on the way in which the data is collected and cleaned by the media platforms 102-106. The example adjustment analyzer circuitry 112 then applies a coverage factor to the data (e.g., the coverage factor may be applied if it is determined that the data may be incomplete (e.g., IP addresses are not captured for some accesses) (block 412).

The example audience data receiver circuitry 120 then determines if there are further media platforms 102-106 to be analyzed (block 414). When there are further media platforms 102-106 to be analyzed, the audience data receiver circuitry 120 obtains data from the next media platform (e.g., the media platform B 104) (block 416) and control returns to block 404 to analyze and adjust the data.

If there are no further media platforms to be analyzed (block 414), the example overlap analyzer circuitry 128 determines an overlapping audience for two or more of the media platforms 102-106 (block 418).

The process 400 of FIG. 4 then ends.

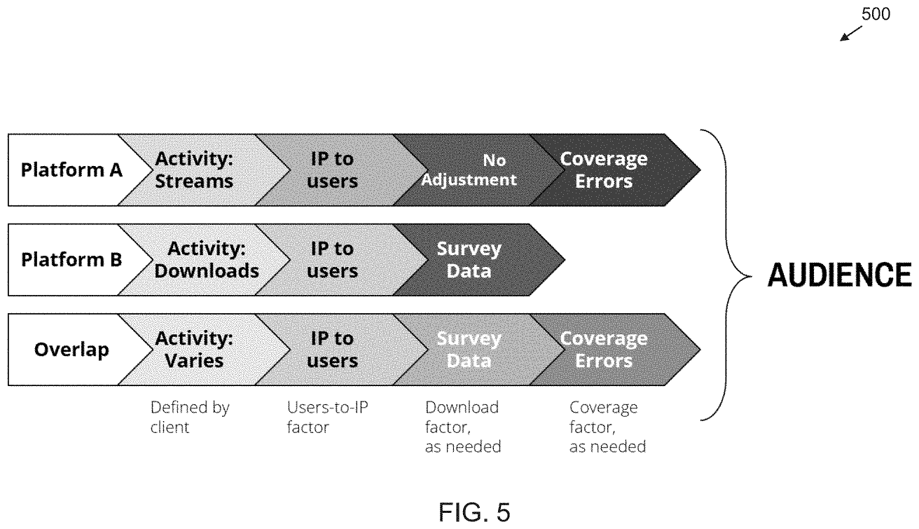

FIG. 5 illustrates an example layout of how audience data is adjusted to determine audiences for ones of the media platforms 102-106 and the overlapping audience for two media platforms.

FIG. 6 is a block diagram of an example processor platform 600 structured to execute and/or instantiate the machine readable instructions and/or the operations of FIG. 4 to implement the apparatus of FIG. 1. The processor platform 600 can be, for example, a server, a personal computer, a workstation, a self-learning machine (e.g., a neural network), a mobile device (e.g., a cell phone, a smart phone, a tablet such as an iPad), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 600 of the illustrated example includes processor circuitry 612. The processor circuitry 612 of the illustrated example is hardware. For example, the processor circuitry 612 can be implemented by one or more integrated circuits, logic circuits, FPGAs, microprocessors, CPUs, GPUs, DSPs, and/or microcontrollers from any desired family or manufacturer. The processor circuitry 612 may be implemented by one or more semiconductor based (e.g., silicon based) devices. In this example, the processor circuitry 612 implements the example audience analyzer circuitry 112 including the example audience data receiver circuitry 120, the example activity analyzer circuitry 122, the example adjustment analyzer circuitry 126, and the example overlap analyzer circuitry 128.

The processor circuitry 612 of the illustrated example includes a local memory 613 (e.g., a cache, registers, etc.). The processor circuitry 612 of the illustrated example is in communication with a main memory including a volatile memory 614 and a non-volatile memory 616 by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. According to the illustrated example, the main memory 614 stores the datastore 124.

The processor platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user to enter data and/or commands into the processor circuitry 612. The input device(s) 622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 600 of the illustrated example also includes one or more mass storage devices 628 to store software and/or data. Examples of such mass storage devices 628 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 632, which may be implemented by the machine readable instructions of FIG. 4, may be stored in the mass storage device 628, in the volatile memory 614, in the non-volatile memory 616, and/or on a removable non-transitory computer readable storage medium such as a CD or DVD.

FIG. 7 is a block diagram of an example implementation of the processor circuitry 612 of FIG. 6. In this example, the processor circuitry 612 of FIG. 6 is implemented by a general purpose microprocessor 700. The general purpose microprocessor circuitry 700 executes some or all of the machine readable instructions of the flowchart of FIG. 4 to effectively instantiate the circuitry of FIG. 1 as logic circuits to perform the operations corresponding to those machine readable instructions. In some such examples, the circuitry of FIG. 1 is instantiated by the hardware circuits of the microprocessor 700 in combination with the instructions. For example, the microprocessor 700 may implement multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowchart of FIG. 4.

The cores 702 may communicate by a first example bus 704. In some examples, the first bus 704 may implement a communication bus to effectuate communication associated with one(s) of the cores 702. For example, the first bus 704 may implement at least one of an Inter-Integrated Circuit (I2C) bus, a Serial Peripheral Interface (SPI) bus, a PCI bus, or a PCIe bus. Additionally or alternatively, the first bus 704 may implement any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2_cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the L1 cache 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating point operations. In yet other examples, the AL circuitry 716 may include first AL circuitry that performs integer based operations and second AL circuitry that performs floating point operations. In some examples, the AL circuitry 716 may be referred to as an Arithmetic Logic Unit (ALU). The registers 718 are semiconductor-based structures to store data and/or instructions such as results of one or more of the operations performed by the AL circuitry 716 of the corresponding core 702. For example, the registers 718 may include vector register(s), SIMD register(s), general purpose register(s), flag register(s), segment register(s), machine specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure including distributed throughout the core 702 to shorten access time. The second bus 722 may implement at least one of an I2C bus, a SPI bus, a PCI bus, or a PCIe bus

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

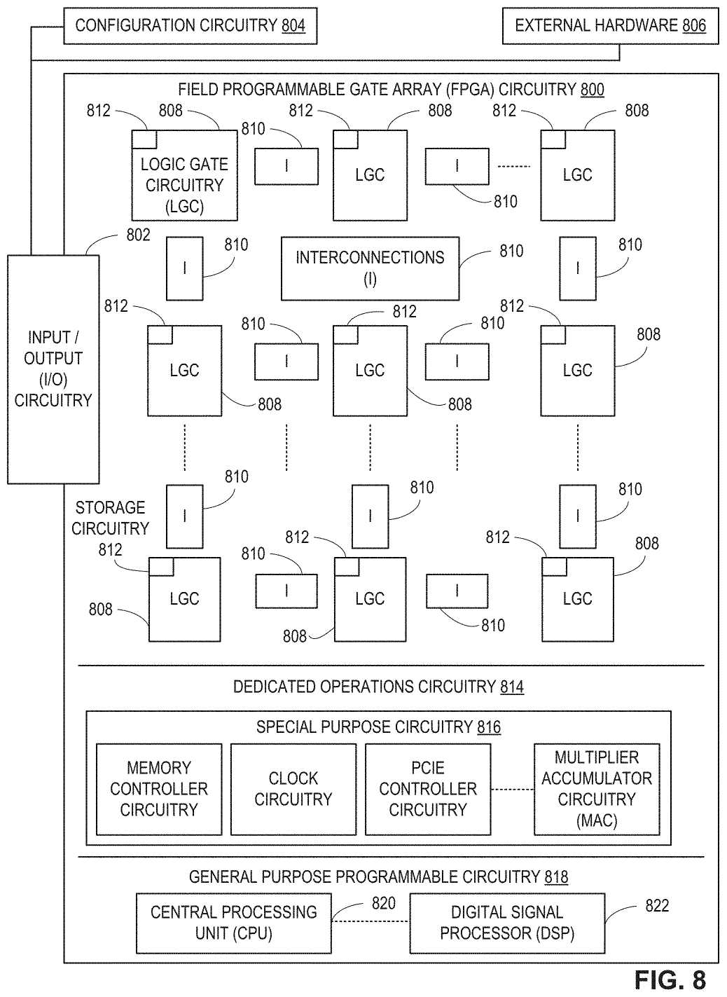

FIG. 8 is a block diagram of another example implementation of the processor circuitry 612 of FIG. 6. In this example, the processor circuitry 612 is implemented by FPGA circuitry 800. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the machine readable instructions in hardware and, thus, can often execute the operations faster than they could be performed by a general purpose microprocessor executing the corresponding software.

More specifically, in contrast to the microprocessor 700 of FIG. 7 described above (which is a general purpose device that may be programmed to execute some or all of the machine readable instructions represented by the flowchart of FIG. 4 but whose interconnections and logic circuitry are fixed once fabricated), the FPGA circuitry 800 of the example of FIG. 8 includes interconnections and logic circuitry that may be configured and/or interconnected in different ways after fabrication to instantiate, for example, some or all of the machine readable instructions represented by the flowchart of FIG. 4. In particular, the FPGA 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the software represented by the flowchart of FIG. 4. As such, the FPGA circuitry 800 may be structured to effectively instantiate some or all of the machine readable instructions of the flowchart of FIG. 4 as dedicated logic circuits to perform the operations corresponding to those software instructions in a dedicated manner analogous to an ASIC. Therefore, the FPGA circuitry 800 may perform the operations corresponding to the some or all of the machine readable instructions of FIG. 4 faster than the general purpose microprocessor can execute the same.

In the example of FIG. 8, the FPGA circuitry 800 is structured to be programmed (and/or reprogrammed one or more times) by an end user by a hardware description language (HDL) such as Verilog. The FPGA circuitry 800 of FIG. 8, includes example input/output (I/O) circuitry 802 to obtain and/or output data to/from example configuration circuitry 804 and/or external hardware (e.g., external hardware circuitry) 806. For example, the configuration circuitry 804 may implement interface circuitry that may obtain machine readable instructions to configure the FPGA circuitry 800, or portion(s) thereof. In some such examples, the configuration circuitry 804 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 806 may implement the microprocessor 700 of FIG. 7. The FPGA circuitry 800 also includes an array of example logic gate circuitry 808, a plurality of example configurable interconnections 810, and example storage circuitry 812. The logic gate circuitry 808 and interconnections 810 are configurable to instantiate one or more operations that may correspond to at least some of the machine readable instructions of FIG. 4 and/or other desired operations. The logic gate circuitry 808 shown in FIG. 8 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations. The logic gate circuitry 808 may include other electrical structures such as look-up tables (LUTs), registers (e.g., flip-flops or latches), multiplexers, etc.

The interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example Dedicated Operations Circuitry 814. In this example, the Dedicated Operations Circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the processor circuitry 612 of FIG. 6, many other approaches are contemplated. For example, as mentioned above, modern FPGA circuitry may include an on-board CPU, such as one or more of the example CPU 820 of FIG. 8. Therefore, the processor circuitry 612 of FIG. 6 may additionally be implemented by combining the example microprocessor 700 of FIG. 7 and the example FPGA circuitry 800 of FIG. 8. In some such hybrid examples, a first portion of the machine readable instructions represented by the flowchart of FIG. 4 may be executed by one or more of the cores 702 of FIG. 7, a second portion of the machine readable instructions represented by the flowchart of FIG. 4 may be executed by the FPGA circuitry 800 of FIG. 8, and/or a third portion of the machine readable instructions represented by the flowchart of FIG. 4 may be executed by an ASIC. It should be understood that some or all of the circuitry of FIG. 1 may, thus, be instantiated at the same or different times. Some or all of the circuitry may be instantiated, for example, in one or more threads executing concurrently and/or in series. Moreover, in some examples, some or all of the circuitry of FIG. 1 may be implemented within one or more virtual machines and/or containers executing on the microprocessor.

In some examples, the processor circuitry 612 of FIG. 6 may be in one or more packages. For example, the processor circuitry 700 of FIG. 5 and/or the FPGA circuitry 800 of FIG. 8 may be in one or more packages. In some examples, an XPU may be implemented by the processor circuitry 612 of FIG. 6, which may be in one or more packages. For example, the XPU may include a CPU in one package, a DSP in another package, a GPU in yet another package, and an FPGA in still yet another package.

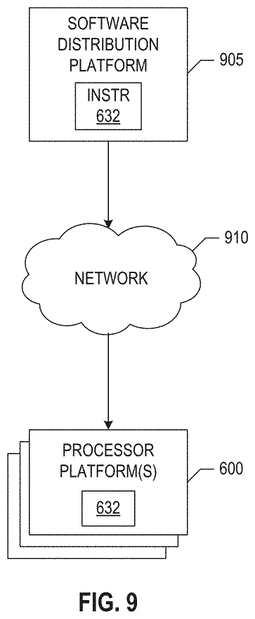

A block diagram illustrating an example software distribution platform 905 to distribute software such as the example machine readable instructions 632 of FIG. 6 to hardware devices owned and/or operated by third parties is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions 400 of FIG. 4, as described above. The one or more servers of the example software distribution platform 905 are in communication with a network 910, which may correspond to any one or more of the Internet and/or any of the example networks 108 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions 400 of FIG. 4, may be downloaded to the example processor platform 600, which is to execute the machine readable instructions 632 to implement the audience analyzer circuitry 112. In some example, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices.

From the foregoing, it will be appreciated that example systems, methods, apparatus, and articles of manufacture have been disclosed that determine audiences and audience overlaps among multiple platforms. Disclosed systems, methods, apparatus, and articles of manufacture improve the efficiency of using a computing device by effectively determine an audience size by using audience measurement data provided by media providers without the need for additional computing devices to monitor each member of an audience. Disclosed systems, methods, apparatus, and articles of manufacture are accordingly directed to one or more improvement(s) in the operation of a machine such as a computer or other electronic and/or mechanical device.

It is noted that this patent claims priority from U.S. Patent Application No. 63/172,369, which was filed on Apr. 8, 2021, and is hereby incorporated by reference in its entirety.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus to determine a deduplicated audience comprising:
audience data receiver circuitry to obtain first audience data from a first media platform; and
processor circuitry including one or more of:
at least one of a central processing unit, a graphic processing unit, or a digital signal processor, the at least one of the central processing unit, the graphic processing unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus;
a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations; or
Application Specific Integrate Circuitry (ASIC) including logic gate circuitry to perform one or more third operations;
the processor circuitry to perform at least one of the first operations, the second operations, or the third operations to instantiate:
activity analyzer circuitry to determine media activities in the first audience data;
adjustment analyzer circuitry to:
apply at least one adjustment factor to the first audience data based on a source of the audience data;
apply a coverage factor adjustment to the first audience data; and
output the adjusted first audience data as a deduplicated audience for the first media platform.

2. The apparatus of claim 1, wherein the audience data receiver circuitry is to obtain second audience data for a second media platform.

3. The apparatus of claim 2, further including an overlap analyzer circuitry to determine an overlapping audience for the first media platform and the second media platform.

4. The apparatus of claim 1, wherein the adjustment factor includes a user to IP address adjustment.

5. The apparatus of claim 1, wherein the coverage factor applies an adjustment to correct for missing information in the first audience data.

6. The apparatus of claim 1, wherein the adjustment factor is based on data collected via a survey.

7. The apparatus of claim 1, further comprising a datastore to store a definition of an activity in the first audience data.

8. A non-transitory computer readable medium comprising instructions that, when executed, cause a machine to at least:
obtain first audience data from a first media platform;
determine media activities in the first audience data;
apply at least one adjustment factor to the first audience data based on a source of the audience data;
apply a coverage factor adjustment to the first audience data; and
output the adjusted first audience data as a deduplicated audience for the first media platform.

9. The non-transitory computer readable medium of claim 8, wherein the instructions, when executed, further cause the machine to obtain second audience data for a second media platform.

10. The non-transitory computer readable medium of claim 9, wherein the instructions, when executed, further cause the machine to determine an overlapping audience for the first media platform and the second media platform.

11. The non-transitory computer readable medium of claim 8, wherein the adjustment factor includes a user to IP address adjustment.

12. The non-transitory computer readable medium of claim 8, wherein the coverage factor applies an adjustment to correct for missing information in the first audience data.

13. The non-transitory computer readable medium of claim 8, wherein the adjustment factor is based on data collected via a survey.

14. The non-transitory computer readable medium of claim 8, wherein the instructions, when executed, further cause the machine to store a definition of an activity in the first audience data.

15. A non-transitory computer readable medium comprising instructions that, when executed, cause a machine to at least:
obtain first audience data from a first media platform;
determine media activities in the first audience data;
apply at least one adjustment factor to the first audience data based on a source of the audience data;
apply a coverage factor adjustment to the first audience data; and
output the adjusted first audience data as a deduplicated audience for the first media platform.

16. The non-transitory computer readable medium of claim 15, wherein the instructions, when executed, further cause the machine to obtain second audience data for a second media platform.

17. The non-transitory computer readable medium of claim 16, wherein the instructions, when executed, further cause the machine to determine an overlapping audience for the first media platform and the second media platform.

18. The non-transitory computer readable medium of claim 15, wherein the adjustment factor includes a user to IP address adjustment.

19. The non-transitory computer readable medium of claim 15, wherein the coverage factor applies an adjustment to correct for missing information in the first audience data.

20. The non-transitory computer readable medium of claim 15, wherein the adjustment factor is based on data collected via a survey.
